(19) United States
(12) Patent Application Publication
(10) Pub. No.: US 2016/0028261 A1
(43) Pub. Date: Jan. 28, 2016

(54) Rechargeable Battery Pack with USB Power Outlet

(71) Applicant: Ryan Powers, Boca Raton, FL (US)

(72) Inventor: Ryan Powers, Boca Raton, FL (US)

(21) Appl. No.: 14/802,189

(22) Filed: Jul. 17, 2015

Related U.S. Application Data
(60) Provisional application No. 62/027,854, filed on Jul. 23, 2014.

(51) Int. Cl. H02J 7/00

(52) U.S. Cl. CPC H02J 7/0045; H02J 7/0052; H02J 7/007; H02J 2007/0059

(57) ABSTRACT

The present invention is a universal serial bus (USB) adapter built into an already existing detachable/rechargeable/or non-rechargeable battery pack. The battery pack is the main source of energy to power cordless tools.

This application claims the benefit and priority of U.S. Ser. No. 62/027,854

### STATEMENT REGARDING FEDERALLY SPONSORED RESEARCH

The invention was not made under government contract nor was funded grant money used to fund the research

### FIELD OF INVENTION

This invention relates to the means of enabling a detachable/rechargeable or non-rechargeable battery pack to recharge or power small electronic by utilizing an integrated universal serial bus (USB) adapter.

Detachable battery packs for cordless drills or similar are already used worldwide. Presently, they do not have the capability to power other devices aside from their intended use. This invention takes advantage of the already existing technology and expand it for use with small rechargeable electronics. This invention will simply adapt the previously described USB adapter port to the existing battery pack.

### SUMMARY OF THE INVENTION

The present invention relates mainly to a detachable/rechargeable battery pack for cordless drills or similar with a built-in universal serial bus (USB) adapter port. This invention will enable users to maximize the utility of the battery pack and expand to other applications aside from powering cordless tools. The end user will have the flexibility to power or recharge small personal electronic devices.

### BACKGROUND OF THE INVENTION

The present invention relates to of a conventional battery pack used in cordless drills or similar battery operated tools. FIG. 1 represents a conventional battery pack and outlines the external mechanical and electrical components. There are in the market, other similar battery packs with different dimensions, electrical characteristic, mating means and locking mechanisms. The invention provides an extension to the already existent electrical circuit by integrating a universal serial bus (USB) in an existing design.

### DRAWINGS

FIG. 1 a conventional battery pack.

FIG. 2 a conventional battery pack with integrated universal serial bus (USB).

FIG. 3 various commercially available universal serial bus (USB) receptacles.

FIG. 4 universal serial bus (USB) power control circuit diagram.

### DETAILED DESCRIPTION OF THE INVENTION

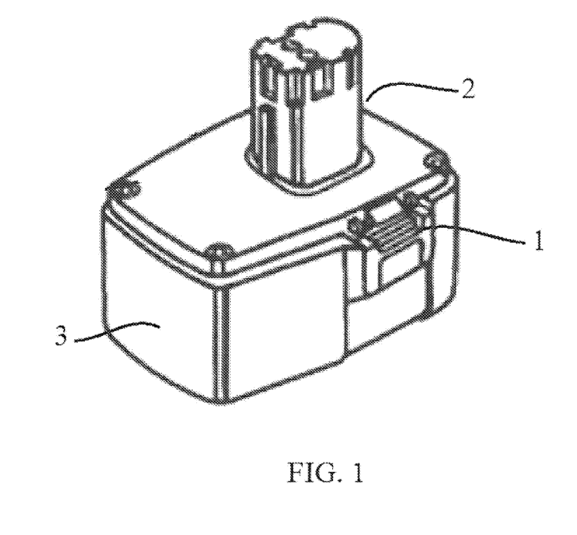

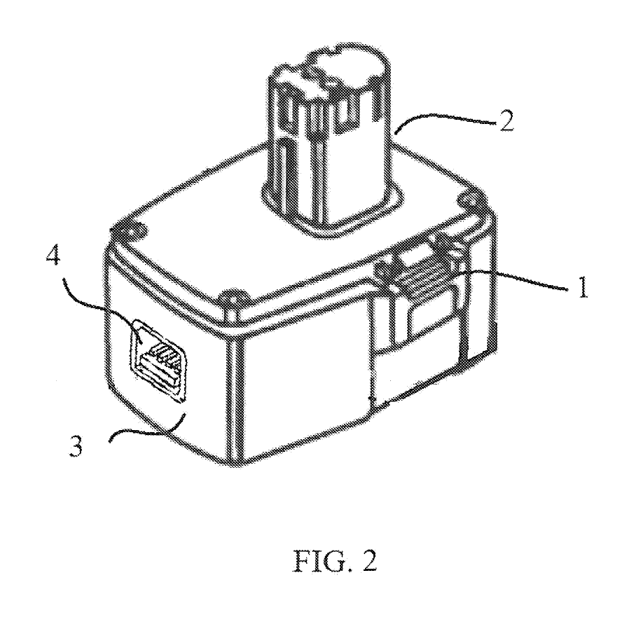

FIG. 1 shows a generic embodiment of a battery pack, the battery pack couples with a cordless drill or similar tool via mating shaft 2. The mating shaft 2 also contains within it electrical contacts positive and negative potential difference that is required to power the tool. The external battery pack enclosure is also equipped with spring loaded locking tabs 1 that provide retention and release from the tool. Typically, inside the enclosures 3, there are several battery cells typically arranged in a series configuration, interconnected with conductive strips providing an overall output voltage to as much as thirty-six volts of direct current. This invention will be using the internal energy from the battery pack as the primary energy source for the universal serial bus (USB) 5 as shown on FIG. 2.

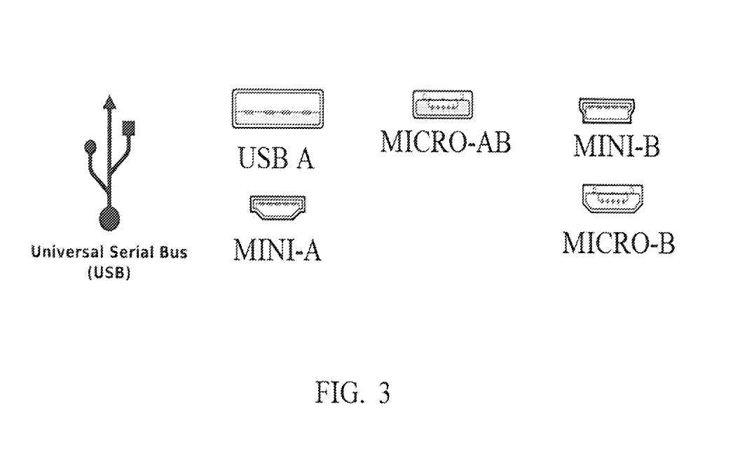

FIG. 2 is an extension of FIG. 1, here, the universal serial bus 4 (USB) is integrated and located on the front panel of the battery pack's enclosure 3. The universal serial bus 4 (USB) can be found in any location around the enclosure most convenient for the application and usage. Furthermore, the universal serial bus 4 (USB) receptacle use in the invention can be of any configuration presently available in the market as further described in FIG. 3.

FIG. 3, describes the presently available USB output receptacle that is available in the market. The type of receptacle used in the invention will depend on space availability within the enclosure.

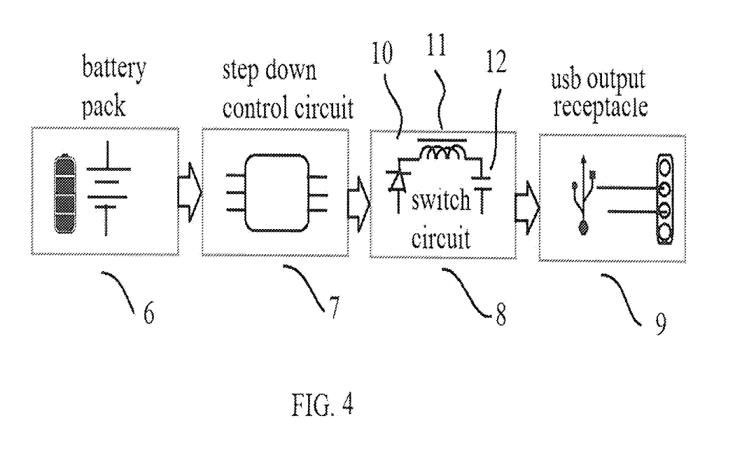

As previously described, this invention will utilize the energy from the integrated battery(s) inside the rechargeable pack as the primary energy source for the integrated universal serial bus as shown on FIG. 2 (3) and FIG. 3. FIG. 4 depicts a block diagram of the internal components that make up the rechargeable battery pack. Additionally, it shows the added electrical circuit not typically found on other rechargeable packs.

First, this particular electrical circuit has one main purpose, and that is, to regulate the incoming voltage between the battery(s) 6 and the USB output receptacle 9 to the outside world. The primary source of energy inside the battery pack is the battery(s) 6. The battery(s) will be electrically coupled to the input of the step-down control circuit 7, best known in the industry as a buck converter. This will be the first stage of voltage control, lowering the voltage. This particular step-down control circuit 7 is capable of working with input voltage ranging from twelve volts up to thirty-six volts, which are ideal for this application, because, commercially battery packs are available in these range of voltages. This will allow this circuit to be adapted to other variations of a rechargeable battery pack, FIG. 1.

The second stage after lowering the voltage is to regulate the output power capacity of the usb output. This is necessary because the output must have a continuous current and a steady output voltage which is necessary to meet the electrical specifications of the universal serial bus (USB) 5. This is accomplished via switch circuit 8 control. The switch circuit 8 control, is a synchronous buck regulator. This means that a clock signal is used to adjust the on/off timing of the switch circuit 8 and is digitally controlled by a signal generated inside the step down control circuit 7. The output power stage control topology of this circuit is achieved by the speed of the powering up and powering down of the diode 10, inductor 11 and capacitor 12 combination. This switched at high speed generated by the step down control circuit 7 can be best described as a pulse width modulation (PWM).

The final stage of the circuit occurs at the USB output receptacle 9, here, the power signal and data signals are split in order to meet the industry requirements for a universal serial bus (USB) adapter 9.

What is claimed is:

1. A rechargeable battery pack with integrated battery (s) and universal serial bus (USB) capable of adapting various receptacle configurations.

2. The conventional battery pack of claim 1, with integrated step down converter circuit, and high speed timing control circuit; and with integrated high speed control signals and an Integrated converter circuit with digital regulated power signals.
